(19) United States
(12) Patent Application Publication
(10) Pub. No.: US 2015/0203651 A1
(43) Pub. Date: Jul. 23, 2015

(54) HIGH WEAR RESISTANCE SHOE SOLE MATERIAL AND MANUFACTURING METHOD THEREOF

(71) Applicant: Gregory Peter Tolchinsky, Brooklyn, NY (US)

(72) Inventor: Gregory Peter Tolchinsky, Brooklyn, NY (US)

(73) Assignee: PGT International LLC, Beaverton, OR (US)

(21) Appl. No.: 14/159,145

(22) Filed: Jan. 20, 2014

(51) Int. Cl. C08K 3/04

(52) U.S. Cl. CPC C08K 3/04

(57) ABSTRACT

The invention discloses a shoe sole material with a high wear resistance and the method of manufacturing the sole material. The disclosed shoe sole composition includes nano-diamond produced by the shock wave method as an inorganic reinforcing filler. The inclusion of nano-diamond as a reinforcing filler increases the life of the shoe sole while reducing the total weight of the shoe. Other reinforcing inorganic fillers such as black carbon, silicon carbide, alumina, etc., can be used in the shoe sole rubber composition in addition to nano-diamond.

### TECHNICAL FIELD

The present invention relates to a high wear resistant shoe sole and to the method of manufacturing said sole.

### BACKGROUND ART

Shoes have become a high-tech product. This is largely due to the increased demand for comfortable and wear resistant footwear, as well as to the evolution of scientific principles and their applications. Many shoe companies spend a considerable amount of resources on research and development of shoes with improved characteristics, such as increased wear resistance and traction. Furthermore, there are numerous patents for shoes with these kinds of improved characteristics. In this application the word shoes will be used to define all types of footwear, including sneakers, high heels, etc., that can be manufactured from natural arid/or synthetic materials.

In the shoe industry, the words outsole and sole are synonymous and used interchangeably. Shoe outsoles make direct contact with the ground, and can be made of natural or synthetic rubber. This rubber, or a combination of this rubber with other materials, is then compounded with additives. Additives can be fillers, plasticizers, vulcanization chemicals, accelerators and etc. The quantity of additives can vary from 20% to 130% of the weight of a rubber polymer. When compounded with the rubber mixture, these additives greatly impact the properties of a shoe sole. Any rubber that is used in the manufacturing of shoe soles is suitable for use in the proposed invention.

The filler is an important additive in any rubber composition. Fillers are needed to fill the gaps between the rubber polymers. They support the network from within, An active filler that improves the elastomers'mechanical properties is called a reinforcing filler. A reinforcing filler can increase the processability of the rubber material and/or modify selected properties of the rubber products, such as tensile strength, wear resistance, tear resistance, etc. Carbon black, precipitated hydrated silica, alumina, zirconium, etc., are all examples of reinforcing fillers.

The effectiveness of a reinforcing filler is determined by its particle shape, size, surface area, compatibility (ability of the particle to adhere to the rubber), etc. Reinforcing fillers with particle sizes less than 100 nm and surface areas greater than 200 m²/g are considered the most suitable for modifying the wear resistance properties of a rubber composition,

U.S. Pat. No. 2,985,607 A proposes the addition of a zirconium compound, H tetra-(2-ethyl-hexanediol-1,3)-zirconate to the filler of a silicone rubber stock. According to U.S. Pat. No. 2,985,607 A, after adding the zirconium compound to the composition, the filler exhibited better cohesiveness than a filler without the zirconium conduct.

Publication Number CN102212216 B describes a high wear resistance sneaker sole comprised of butadiene rubber, natural rubber, styrene butadiene rubber, softening oil, a reinforcing agent, an activating agent, a coupling agent, a vulcanizer, a vulcanization accelerator, a tackifier and an anti-aging agent. The reinforcing agent in CN102212216 B is precipitated hydrated silica.

Publication Number CN102850604 A discloses a wear and water resistant sole material made from the following materials in parts per weight: “80-85 parts of natural rubber, 40-50 parts of triethanolamine, 23-30 parts of white carbon black, 13-16 parts of oil-filled TPE (thermoplastic elastomer), 6-8 parts of dipropylene glycol, 7 parts of dicumyl peroxide, 3-6 parts of plasticizer DOP (dioctyl phthalate) and 7-8 parts of pentane.” The reinforcing filler in CN102850604 A is white carbon black.

Some significant issues in the use of the reinforcement fillers mentioned above are: (1) an increased weight of the shoe due to the relatively high density of the filler material and (2) a hindered. processability of the rubber composition due to an elevated viscosity arising from the addition of a significant amount of filler.

### DETAILED DESCRIPTION OF THE INVENTION

The present invention utilizes nano-diamond as a reinforcing filler in a rubber composition for shoe soles. Other fillers such as carbon black, silica, etc., can be added to the composition with the nano-diamond. The quantity of additional reinforcing fillers may vary within a wide range and can be more than the quantity of nano-diamond.

The nano-diamond utilized in this invention is produced by an explosive shock wave method. Some unique properties of nano-diamond produced by this method include: very small particle size, high hardness, high chemical surface reactivity and high specific surface area. Furthermore, the nano-diamond produced by this method has a deformed crystal lattice. The deformed lattice assures a very high reaction ability. Nano-diamond in powder and solutions retains a wide variety of functional groups on its surface, including: oxygen, nitrogen, hydrogen, etc. When nano-diamond is added to a rubber composition, its surface functional groups facilitate network formation and become readily available for interactions with polymer chains of the rubber network.

Characteristics of the reinforcing nano-diamond filler as proposed for use in this invention are:
Specific surface area between 200 and 450 m²/g (BET)
Particle size between 2 and 100 nm. Nano-diamond powder consists of primary and secondary particles. The primary particles have ˜2-6 nm size range and the secondary particles are clusters of the primary and secondary particles with total size range from 10 to 100 nm.
Hardness up to ˜90 GPa
Thermal conductivity of 600-1000 W/mK
High chemical stability (corrosion-resistant, acid-resistant and base-resistant)
Low toxicity to humans and other living organisms ecologically friendly)

Nano-diamond has an exceptional dispersibility throughout the rubber composition matrix. Furthermore, its addition to the rubber composition would not require any significant changes to the shoe sole manufacturing process. To improve the mixing uniformity of the materials, author proposes the addition of nano-diamond to the rubber composition before or together with any supplementary reinforcing inorganic filler.

The addition of nano-diamond as a reinforcing filler to the rubber composition in quantities of 0.1-7.5 phr on 100 phr of elastomer (parts per hundred parts of elastomer by weight), will significantly increase the wear resistance of a shoe sole.

What is claimed is:

1. A rubber composition for a wear resistant shoe sole, which is comprised of nano-diamond as an inorganic reinforcing filler. Nano-diamond used in this invention is produced by an explosive shock wave method and has a particle size of 2-100 nm and a specific surface area of 200-450 m²/g (BET).

2. The composition in claim 1 where the quantity of nano-diamond in a rubber composition is 0.1-7.5 phr on 100 phr of elastomer (parts per weight per hundred parts of elastomer).

3. The composition according to claim 1, where in addition to nano-diamond, other reinforcing inorganic fillers such as black carbon, silicon carbide, alumina, etc., can be added to the composition.

4. The composition according to claim 3, where to improve mixing uniformity, nano-diamond is added to the rubber composition before or together with additional reinforcing inorganic filters.
